(19) United States
(12) Patent Application Publication
(10) Pub. No.: US 2023/0415320 A1
(43) Pub. Date: Dec. 28, 2023

(54) ELECTRIC POWER TOOL

(71) Applicant: Basso Industry Corp., Taichung (TW)

(72) Inventors: Cheng-En TSAI, Taichung (TW); Chong-Kun HONG, Taichung (TW)

(73) Assignee: Basso Industry Corp., Taichung (TW)

(21) Appl. No.: 18/339,373

(22) Filed: Jun. 22, 2023

(30) Foreign Application Priority Data
Jun. 24, 2022 (TW) 111123733

(51) Int. Cl. B25C 1/06

(52) U.S. Cl. CPC B25C 1/06

(57) ABSTRACT

An electric power tool includes a power supply supplying electricity, a driving unit driving operation of the electric power tool, an operation unit to be operated by a user, main and redundant sensing units detecting the power supply, the driving unit and the operation unit, and a control unit including primary and secondary controllers that respectively make first and second determinations according to the detection made by the main and redundant sensing units. The control unit controls the driving unit to operate in a normal mode when both of the first and second determinations indicate that at least one of the power supply, the driving unit and the operation unit operates normally.

### CROSS-REFERENCE TO RELATED APPLICATION

This application claims priority to Taiwanese Invention patent application No. 111123733, filed on Jun. 24, 2022.

### FIELD

The disclosure relates to an electric power tool, and more particularly to an electric power tool with redundancy.

### BACKGROUND

As electric power tools become increasingly versatile, mechanisms of the electric power tools become more complex. When an electric power tool operates abnormally due to failure of one component (e.g., a switch or a sensor) of the electric power tool or external environmental interferences, the electric power tool may be unsafe to use.

### SUMMARY

Therefore, an object of the disclosure is to provide an electric power tool that can alleviate at least one of the drawbacks of the prior art.

According to the disclosure, the electric power tool includes a housing, a power supply, a driving unit, an operation unit, a main sensing unit, a redundant sensing unit and a control unit.

The power supply is accommodated in the housing, and is configured to supply electricity.

The driving unit is accommodated in the housing, is electrically connected to the power supply, and is configured to drive operation of the electric power tool based on the electricity from the power supply.

The operation unit is accommodated in the housing, and is configured to be operated by a user using the electric power tool.

The main sensing unit is accommodated in the housing, and is configured to detect the power supply, the driving unit and the operation unit.

The redundant sensing unit is accommodated in the housing, and is configured to detect at least one of the power supply, the driving unit and the operation unit.

The control unit is electrically connected to the power supply, the driving unit and the operation unit, and includes a primary controller and a secondary controller.

The primary controller is in communication with the main sensing unit, and is configured to make a first determination related to condition of the power supply, the driving unit and the operation unit according to the detection made by the main sensing unit.

The secondary controller is in communication with the redundant sensing unit, and is configured to make a second determination related to condition of at least one of the power supply, the driving unit and the operation unit according to the detection made by the redundant sensing unit.

The control unit is configured to control the driving unit to operate in a normal mode where the driving unit enables the electric power tool to function normally when both of the first determination and the second determination indicate that the at least one of the power supply, the driving unit and the operation unit operates normally.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating an electric power tool according to a first embodiment of the disclosure.

FIG. 2 is a sectional view of the electric power tool along an imaginary sectional line Il-Il shown in FIG. 1.

FIG. 3 is a block diagram illustrating the electric power tool according to the first embodiment of the disclosure.

FIG. 4 is a circuit diagram illustrating a trigger sensor of the electric power tool according to an embodiment of the disclosure.

FIG. 5 is a flow chart illustrating an operation procedure of the electric power tool when the electric power tool normally operates according to the first embodiment of the disclosure.

FIGS. 6 to 9 are flow charts illustrating checking procedures of the electric power tool according to an embodiment of the disclosure.

FIG. 10 is a block diagram illustrating the electric power tool according to a second embodiment of the disclosure.

FIG. 11 is a flow chart illustrating an operation procedure of the electric power tool when the electric power tool normally operates according to the second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

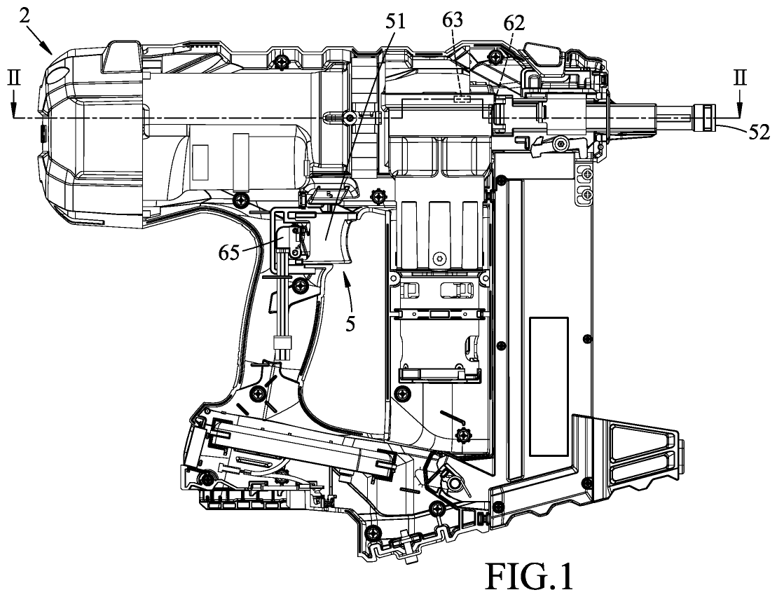

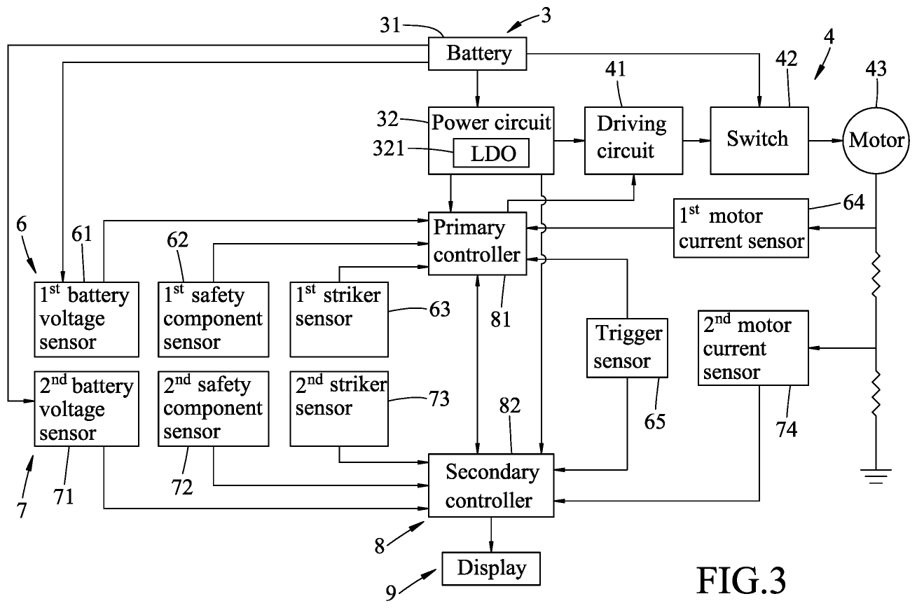

Referring to FIGS. 1 to 3, a first embodiment of an electric power tool according to the disclosure is illustrated. The electric power tool is exemplarily a nail gun, but is not limited thereto. Particularly, the electric power tool may be a pneumatic nail gun or an electric nail gun. Since technical details about the pneumatic nail gun and the electric nail gun have been well known to one skilled in the relevant art (e.g., U.S. Pat. No. 8,011,547B2 for the pneumatic nail gun, and Taiwanese Invention Patent Application Publication No. 202134018A and Japanese Patent Application Publication No. 2022068526A for the electric nail gun), detailed explanation of the same is omitted herein for the sake of brevity.

The electric power tool includes a housing 2, a power supply 3, a driving unit 4, an operation unit 5, a main sensing unit 6, a redundant sensing unit 7 and a control unit 8. The electric power tool optionally includes a display 9. The control unit 8 is electrically connected to the power supply 3, the driving unit 4, the operation unit 5, the main sensing unit 6, the redundant sensing unit 7 and the display 9. In this embodiment, the electric power tool, which is embodied as a nail gun, further includes a striker 631 for hitting a nail.

The power supply 3 is accommodated in the housing 2, and is configured to supply electricity. The power supply 3 includes a battery 31 and a power circuit 32 that are electrically connected to each other. The power circuit 32 may include a low-dropout (LDO) regulator 321. The power circuit 32 is configured to perform voltage regulation and voltage conversion on the electricity provided by the battery 31 and to transfer the electricity thus processed to other components of the electric power tool. Since implementation of the power circuit 32 has been well known to one skilled in the relevant art, detailed explanation of the same is omitted herein for the sake of brevity.

The driving unit 4 is accommodated in the housing 2. The driving unit 4 is electrically connected to the power supply 3, and is configured to drive operation of the electric power tool (e.g., firing a nail) based on the electricity from the power supply 3. The driving unit 4 includes a driving circuit 41, a switch 42 that is electrically connected to the driving circuit 41, and a motor 43 that is electrically connected to the switch 42. The driving circuit 41 is configured to receive a pulse-width modulation (PWM) signal outputted by the control unit 8, and to control the switch 42 according to a duty ratio of the PWM signal so as to enable the motor 43 to rotate at a specific speed corresponding to the duty ratio. The switch 42 may be implemented by a semiconductor switch (e.g., a metal-oxide-semiconductor field-effect transistor, MOSFET, or an insulated gate bipolar transistor, IGBT), but is not limited thereto. The motor 43 may be implemented by a brushless DC electric motor (BLDC), but is not limited thereto. Since implementation of the driving circuit 41 has been well known to one skilled in the relevant art, detailed explanation of the same is omitted herein for the sake of brevity.

The operation unit 5 is disposed on the housing 2, and is configured to be operated by a user using the electric power tool. The operation unit 5 includes a trigger 51 and a safety component 52. It is worth to note that in some embodiments, the electric power tool allows the user to change the settings of the electric power tool by pressing the trigger 51 and the safety component 52 in a specific order. In some embodiments, the operation unit 5 further includes a control panel that has buttons (not shown), and the electric power tool allows the user to change the settings of the electric power tool by operating the buttons of the control panel.

The main sensing unit 6 is accommodated in the housing 2. The main sensing unit 6 is configured to detect the power supply 3, the driving unit 4, the operation unit 5 and the striker 631. The main sensing unit 6 includes a plurality of types of sensors for detecting the power supply 3, the driving unit 4, the operation unit 5 and the striker 631. In particular, the main sensing unit 6 includes a first battery voltage sensor 61, a first safety component sensor 62, a first striker sensor 63, a first motor current sensor 64 and a trigger sensor 65.

The redundant sensing unit 7 is accommodated in the housing 2. The redundant sensing unit 7 is configured to provide redundancy for the main sensing unit 6, and to detect at least one of the power supply 3, the driving unit 4, the operation unit 5 and the striker 631 (hereinafter referred to as “target component”). The redundant sensing unit 7 includes at least one type of sensor that is a type identical to one of the types of sensors of the main sensing unit 6 and that is for detecting one of the power supply 3, the driving unit 4, the operation unit 5 and the striker 631. In particular, the redundant sensing unit 7 includes a second battery voltage sensor 71, a second safety component sensor 72, a second striker sensor 73 and a second motor current sensor 74.

Both of the first battery voltage sensor 61 and the second battery voltage sensor 71 are electrically connected to the battery 31, and are configured to detect a voltage value of the battery 31. Both of the first motor current sensor 64 and the second motor current sensor 74 are electrically connected to the motor 43, and are configured to detect a current value of the motor 43. Both of the first safety component sensor 62 and the second safety component sensor 72 are configured to determine whether the safety component 52 is pressed. The trigger sensor 65 is configured to determine whether the trigger 51 is pressed. Both of the first striker sensor 63 and the second striker sensor 73 are configured to determine whether the striker 631 returns to a predetermined position after the electric power tool has been triggered. Since implementation of the aforesaid detection has been well known to one skilled in the relevant art, detailed explanation of the same is omitted herein for the sake of brevity.

The control unit 8 includes a primary controller 81 and a secondary controller 82. The primary controller 81 is in communication with the main sensing unit 6 and the secondary controller 82, and is electrically connected to the driving unit 4. The secondary controller 82 is electrically connected to the display 9. The primary controller 81 is configured to make a first determination related to condition of the power supply 3, the driving unit 4, the operation unit 5 and the striker 631 according to the detection made by the main sensing unit 6. The secondary controller 82 is in communication with the redundant sensing unit 7, and is configured to make a second determination related to condition of the target component according to the detection made by the redundant sensing unit 7. The control unit 8 is configured to control the driving unit 4 to operate in a normal mode where the driving unit 4 enables the electric power tool to function normally for firing a nail when both of the first determination and the second determination indicate that said at least one of the power supply 3, the driving unit 4, the operation unit 5 and the striker 631 operates normally, and to control the driving unit 4 to operate in an abnormal mode where the driving unit 4 disables the electric power tool from functioning normally (e.g., stopping the motor 43 which is operating or disabling activation of the motor 43) when one of the first determination and the second determination indicates that the at least one of the power supply 3, the driving unit 4, the operation unit 5 and the striker 631 operates abnormally. The secondary controller 82 is further configured to control the display 9 to present a visual output when it is determined that the at least one of the power supply 3, the driving unit 4 and the operation unit 5 operates abnormally. The display 9 may be implemented by a light bulb, a liquid-crystal display (LCD), a light-emitting diode (LED) display, a plasma display panel, a projection display or the like. However, implementation of the display 9 is not limited to the disclosure herein and may vary in other embodiments. The visual output is used to notify the user that abnormality occurs in the electric power tool, and may be implemented as flashing, continuous illumination, text, graphics or the like.

Specifically, in some embodiments, the secondary controller 82 is further configured to output a notification signal to the primary controller 81 when the second determination indicates that the at least one of the power supply 3, the driving unit 4 and the operation unit 5 operates normally. The primary controller 81 is further configured to output a control signal to the driving unit 4 for controlling the driving unit 4 to operate in one of the normal mode and the abnormal mode based on the first determination and whether the notification signal is received.

In some embodiments, the secondary controller 82 is further configured to output a notification signal to the primary controller 81 when the second determination indicates that the at least one of the power supply 3, the driving unit 4 and the operation unit 5 operates abnormally. The primary controller 81 is further configured to output a control signal to the driving unit 4 for controlling the driving unit 4 to operate in one of the normal mode and the abnormal mode based on the first determination and whether the notification signal is received.

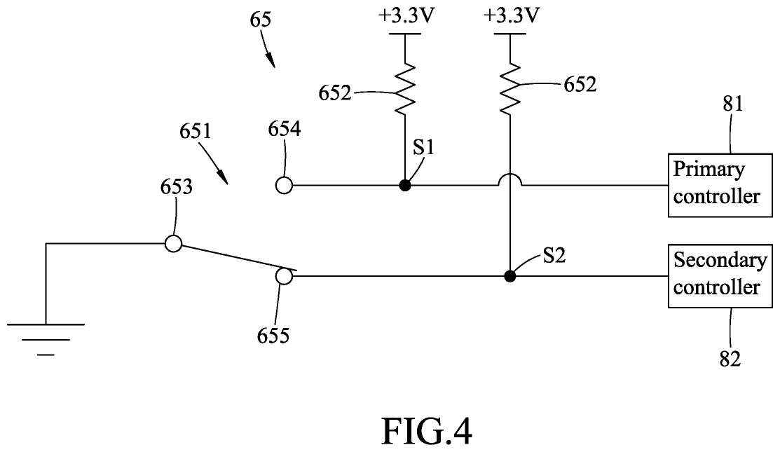

Referring to FIG. 4, the trigger sensor 65 includes a micro switch 651 and two resistors 652. The micro switch 651 has a first terminal 653 that is electrically connected to a low voltage (e.g., 0 V), a second terminal 654 that is electrically connected to the primary controller 81, and a third terminal 655 that is electrically connected to the secondary controller 82. The micro switch 651 is interlocked with the trigger 51, and is configured to switch, upon pressing of the trigger 51, between a first state where the first terminal 653 and the second terminal 654 are connected while the first terminal 653 and the third terminal 655 are disconnected, and a second state where the first terminal 653 and the second terminal 654 are disconnected while the first terminal 653 and the third terminal 655 are connected. Each of the two resistors 652 has one end electrically connected to a high voltage (e.g., 3.3V), the other end of one of the two resistors 652 is electrically connected to the second terminal 654 of the micro switch 651, and the other end of the other one of the two resistors 652 is electrically connected to the third terminal 655 of the micro switch 651. It should be noted that no matter which one of the first state and the second state that the micro switch 651 is switched to, voltages respectively of two nodes (S1, S2) in FIG. 4 would vary upon switching of the micro switch 651, and each of the primary controller 81 and the secondary controller 82 determines that the trigger 51 is pressed when it is determined that the corresponding one of the voltages respectively of the two nodes (S1, S2) varies.

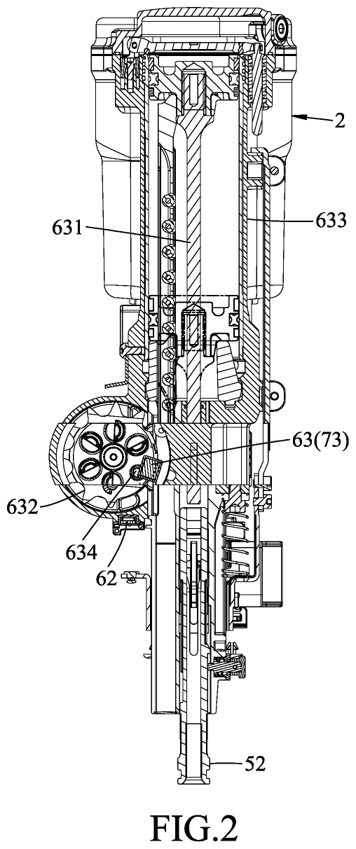

In one embodiment where the electric power tool is the pneumatic nail gun, the electric power tool further includes a rotary-to-linear lifter 632, a pneumatic cylinder 633 and a magnet 634 as shown in FIG. 2. Each of the first striker sensor 63 and the second striker sensor 73 is implemented by a Hall effect sensor that is disposed near to the rotary-to-linear lifter 632. The magnet 634 is mount on the rotary-to-linear lifter 632. The striker 631 is movably disposed in the pneumatic cylinder 633. The rotary-to-linear lifter 632 is connected to the striker 631 and the motor 43. The compressed gas inside the pneumatic cylinder 633 is used to drive the striker 631 to move from an initial position (which serves as the predetermined position) in a firing direction (i.e., the downward direction in FIG. 2), and the motor 43 is configured to drive the rotary-to-linear lifter 632 to rotate so as to move the striker 631 back to the initial position in an opposite direction that is opposite to the firing direction (i.e., the upward direction in FIG. 2). When the striker 631 is positioned at the initial position, a distance between the magnet 634 mounted on the rotary-to-linear lifter 632 and each of the first striker sensor 63 and the second striker sensor 73 would be the shortest, making each of the first striker sensor 63 and the second striker sensor 73 detects presence of the magnet 634. Accordingly, each of the first striker sensor 63 and the second striker sensor 73 determines that the striker 631 returns to the predetermined position after the electric power tool has been triggered when twice detecting the presence of the magnet 634.

In another embodiment where the electric power tool is the electric nail gun (referring to Taiwanese Invention Patent Application Publication No. 202134018A), the electric power tool further includes a transmission assembly (not shown), an impact spring (not shown) and an impact frame (not shown). Each of the first striker sensor 63 and the second striker sensor 73 is implemented by a micro switch that is to be triggered to transition states thereof by touch of an impact frame. The impact frame is interlocked with the striker 631, and is co-movable with the striker 631. Each of the transmission assembly and the impact spring is connected to the striker 631, and the transmission assembly is further connected to the motor 43. The impact spring is configured to exert a restoring force on the striker 631 to drive the striker 631 to move from the initial position in the firing direction, and the motor 43 is configured to drive the transmission assembly to rotate so as to move the striker 631 back to the initial position in the opposite direction. When the striker 631 is positioned at the initial position, the impact frame touches each of the first striker sensor 63 and the second striker sensor 73, triggering the first striker sensor 63 and the second striker sensor 73 to transition states thereof. Accordingly, after the electric power tool has been triggered, each of the first striker sensor 63 and the second striker sensor 73 determines that the striker 631 returns to the predetermined position when each of the first striker sensor 63 and the second striker sensor 73 has been touched again by the impact frame.

Hereinafter, detailed explanation of four checking procedures that are related to detection made by the main sensing unit 6 and the redundant sensing unit 7 (more specifically, detection made by the first battery voltage sensor 61, the first safety component sensor 62, the first striker sensor 63, the first motor current sensor 64, the trigger sensor 65, the second battery voltage sensor 71, the second safety component sensor 72, the second striker sensor 73 and the second motor current sensor 74 for the battery 31, the safety component 52, the striker 631, the motor 43 and the trigger 51) are described.

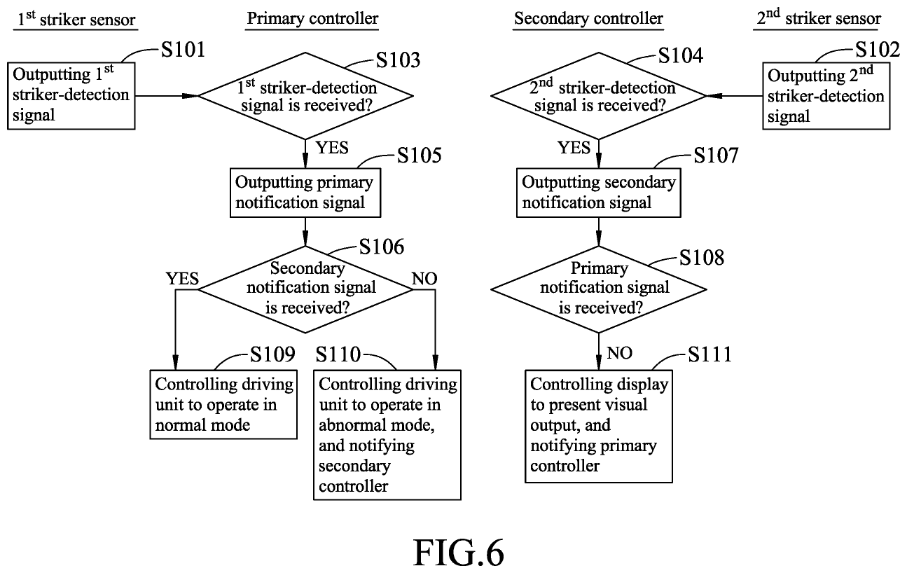

Referring to FIG. 6, an embodiment of a checking procedure that is related to the striker 631 (target component) is illustrated. This checking procedure includes steps S101 to S111 delineated below.

The first striker sensor 63 determines whether the striker 631 returns to the predefined position after the electric power tool has been triggered, and outputs a first striker-detection signal to the primary controller 81 in step S101 when it is determined that the striker 631 returns to the predefined position.

The second striker sensor 73 determines whether the striker 631 returns to the predefined position after the electric power tool has been triggered, and outputs a second striker-detection signal to the secondary controller 82 in step S102 when it is determined that the striker 631 returns to the predefined position.

In step S103, the primary controller 81 makes the first determination by determining whether the first striker-detection signal is received within a preset striker-returning period (e.g., 0.5 seconds). When it is determined that the first striker-detection signal is received within the preset striker-returning period, a flow of procedure proceeds to step S105 and step S106. It should be noted that the order of executing steps S105 and S106 is arbitrary, and is not limited to what are disclosed herein. In some embodiments, steps S105 and S106 may be executed at the same time. When it is determined that the first striker-detection signal is not received within the preset striker-returning period, the flow of procedure proceeds to step S110.

In step S104, the secondary controller 82 makes the second determination by determining whether the second striker-detection signal is received within the preset striker-returning period. When it is determined that the second striker-detection signal is received within the preset striker-returning period, the flow of procedure proceeds to step S107 and step S108. It should be noted that the order of executing steps S107 and S108 is arbitrary, and is not limited to what are disclosed herein. In some embodiments, steps S107 and S108 may be executed at the same time. When it is determined that the second striker-detection signal is not received within the preset striker-returning period, the flow of procedure proceeds to step S111.

In step S105, the primary controller 81 outputs a primary notification signal to the secondary controller 82. Similarly, in step S107, the secondary controller 82 outputs a secondary notification signal to the primary controller 81.

In step S106, the primary controller 81 determines whether the secondary notification signal is received from the secondary controller 82 within a preset notification period (e.g., two seconds). When it is determined that the secondary notification signal is received within the preset notification period, the flow of procedure proceeds to step S109. Otherwise, when it is determined that the secondary notification signal is not received within the preset notification period, the flow of procedure proceeds to step S110.

In step S108, the secondary controller 82 determines whether the primary notification signal is received from the primary controller 81 within the preset notification period. When it is determined that the primary notification signal is not received within the preset notification period, the flow of procedure proceeds to step S111. In some embodiments, when it is determined in step S108 that the primary notification signal is received within the preset notification period, the secondary controller 82 will not execute any further steps.

In step S109, the primary controller 81 controls the driving unit 4 to operate in the normal mode.

In step S110, the primary controller 81 controls the driving unit 4 to operate in the abnormal mode so as to stop operation of the motor 43, and notifies the secondary controller 82 to control the display 9 to present the visual output.

In step S111, the secondary controller 82 controls the display 9 to present the visual output, and notifies the primary controller to stop operation of the motor 43.

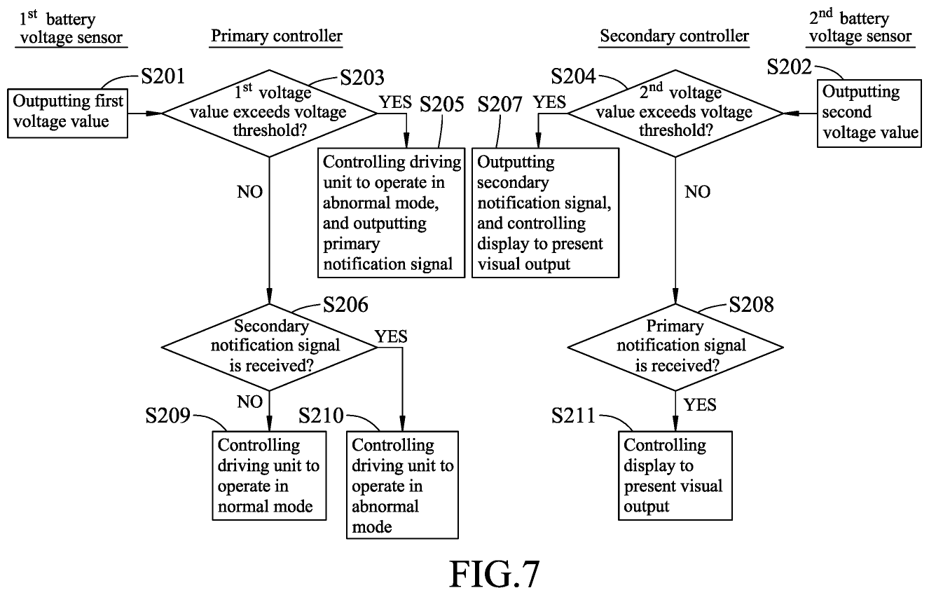

Referring to FIG. 7, an embodiment of a checking procedure that is related to the battery 31 (target component) is illustrated. This checking procedure includes steps S201 to S211 delineated below.

In step S201, the first battery voltage sensor 61 detects a first voltage value of the battery 31, and outputs the first voltage value to the primary controller 81. Similarly, in step S202, the second battery voltage sensor 71 detects a second voltage value of the battery 31, and outputs the second voltage value to the secondary controller 82.

In step S203, the primary controller 81 makes the first determination by determining whether the first voltage value exceeds a voltage threshold. The voltage threshold may be dynamically determined by the primary controller 82 according to residual power of the battery 31. When it is determined that the first voltage value exceeds the voltage threshold (i.e., the electric power tool operates abnormally), a flow of the procedure proceeds to step S205. On the other hand, when it is determined that the first voltage value does not exceed the voltage threshold (i.e., the electric power tool operates normally), the flow of the procedure proceeds to step S206.

In step S204, the secondary controller 82 makes the second determination by determining whether the second voltage value exceeds the voltage threshold. When it is determined that the second voltage value exceeds the voltage threshold, the flow of the procedure proceeds to step S207. On the other hand, when it is determined that the second voltage value does not exceed the voltage threshold, the flow of the procedure proceeds to step S208.

When it is determined that the first voltage value exceeds the voltage threshold, in step S205, the primary controller 81 controls the driving unit 4 to operate in the abnormal mode so as to stop operation of the motor 43, and outputs a primary notification signal to the secondary controller 82 so as to enable the secondary controller 82 to control the display 9 to present the visual output. When it is determined that the second voltage value exceeds the voltage threshold, in step S207, the secondary controller 82 determines that the power supply 3 operates abnormally, outputs the secondary notification signal to the primary controller 81, and controls the display 9 to present the visual output.

In step S206, the primary controller 81 determines whether the secondary notification signal is received from the secondary controller 82 within the preset notification period. When it is determined that the secondary notification signal is not received within the preset notification period, the flow of the procedure proceeds to step S209. Oppositely, when it is determined that the secondary notification signal is received within the preset notification period, the flow of the procedure proceeds to step S210.

In step S208, the secondary controller 82 determines whether the primary notification signal is received from the primary controller 81 within the preset notification period. When it is determined that the primary notification signal is received within the preset notification period, the flow of the procedure proceeds to step S211. In some embodiments, when it is determined in step S208 that the primary notification signal is not received within the preset notification period, the secondary controller 82 will not execute any further steps.

In step S209, the primary controller 81 controls the driving unit 4 to operate in the normal mode.

In step S210, the primary controller 81 controls the driving unit 4 to operate in the abnormal mode so as to stop operation of the motor 43.

In step S211, the secondary controller 82 controls the display 9 to present the visual output.

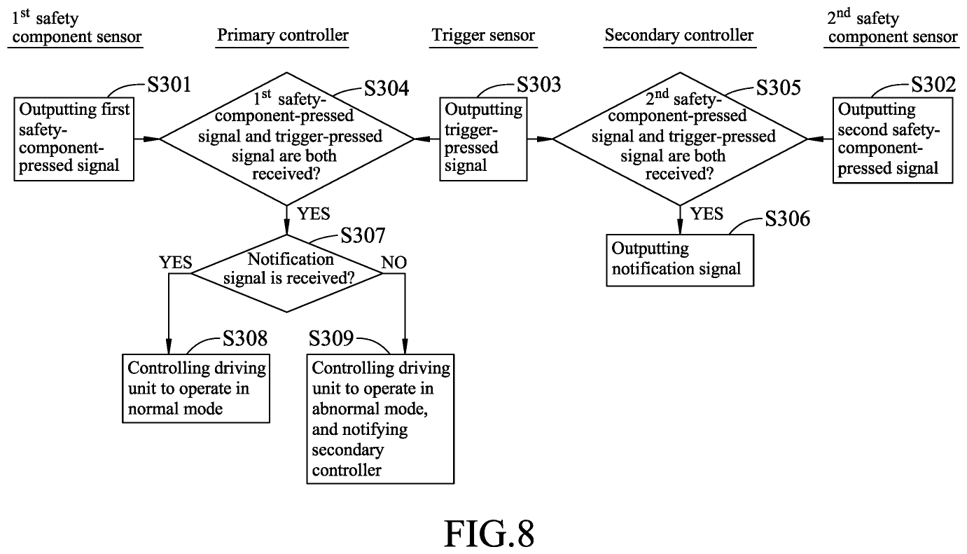

Referring to FIG. 8, an embodiment of a checking procedure that is related to the trigger 51 and the safety component 52 (target components) is illustrated. This checking procedure includes steps S301 to S309 delineated below.

The first safety component sensor 62 determines whether the safety component 52 is pressed, and outputs a first safety-component-pressed signal to the primary controller 81 in step S301 when it is determined that the safety component 52 is pressed.

The second safety component sensor 72 determines whether the safety component 52 is pressed, and outputs a second safety-component-pressed signal to the secondary controller 82 in step S302 when it is determined that the safety component 52 is pressed.

The trigger sensor 65 determines whether the trigger 51 is pressed, and outputs a trigger-pressed signal to both of the primary controller 81 and the secondary controller 82 in step S303 when it is determined that the trigger 51 is pressed.

In step S304, the primary controller 81 makes the first determination by determining whether the first safety-component-pressed signal and the trigger-pressed signal are both received within a preset triggering period (e.g., 0.5 seconds). When it is determined that the first safety-component-pressed signal and the first trigger-pressed signal are received within the preset triggering period, a flow of the procedure proceeds to step S307. When it is determined that any one of the first safety-component-pressed signal and the first trigger-pressed signal is not received within the preset triggering period, the primary controller 81 does not do anything and the method terminates.

In step S305, the secondary controller 82 makes the second determination by determining whether the second safety-component-pressed signal and the trigger-pressed signal are both received within the preset triggering period. When it is determined that the second safety-component-pressed signal and the second trigger-pressed signal are received within the preset triggering period, the flow of the procedure proceeds to step S306. When it is determined that any one of the second safety-component-pressed signal and the second trigger-pressed signal is not received within the preset triggering period, the secondary controller 82 does not do anything and the method terminates.

In step S306, the secondary controller 82 outputs a notification signal to the primary controller 81.

In step S307, the primary controller 81 determines whether the notification signal is received from the secondary controller 82 within the preset notification period. When it is determined that the notification signal is received within the preset notification period, the flow of the procedure proceeds to step S308. Contrarily, when it is determined that the notification signal is not received within the preset notification period, the flow of the procedure proceeds to step S309.

In step S308, the primary controller 81 controls the driving unit 4 to operate in the normal mode.

In step S309, the primary controller 81 controls the driving unit 4 to operate in the abnormal mode so as to stop operation of the motor 43, and notifies the secondary controller 82 to control the display 9 to present the visual output.

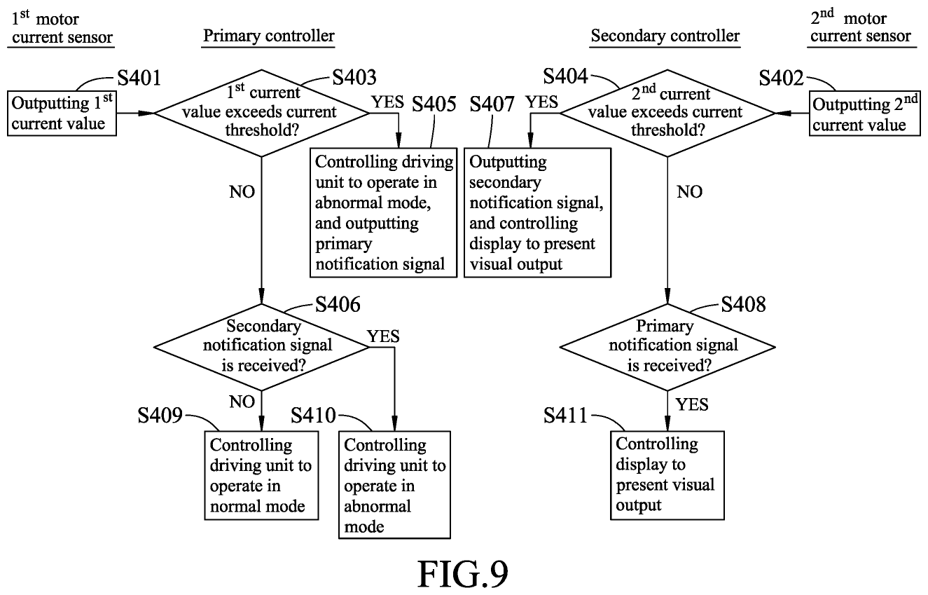

Referring to FIG. 9, an embodiment of a checking procedure that is related to the motor 43 (target component) is illustrated. This checking procedure includes steps S401 to S411 delineated below.

In step S401, the first motor current sensor 64 detects a first current value of the motor 43, and outputs the first current value to the primary controller 81. Similarly, in step S402, the second motor current sensor 74 detects a second current value of the motor 43, and outputs the second current value to the secondary controller 82.

In step S403, the primary controller 81 determines whether the first current value exceeds a current threshold that is related to a rated current of the motor 43. When it is determined that the first current value exceeds the current threshold (i.e., the electric power tool operates abnormally), a flow of the procedure proceeds to step S405. On the other hand, when it is determined that the first current value does not exceed the voltage threshold (i.e., the electric power tool operates normally), the flow of the procedure proceeds to step S406.

In step S404, the secondary controller 82 determines whether the second current value exceeds the current threshold. When it is determined that the second current value exceeds the current threshold, the flow of the procedure proceeds to step S407. On the other hand, when it is determined that the second current value does not exceed the current threshold, the flow of the procedure proceeds to step S408.

When it is determined that the first current value exceeds the current threshold, in step S405, the primary controller 81 controls the driving unit 4 to operate in the abnormal mode so as to stop operation of the motor 43, and outputs a primary notification signal to the secondary controller 82 so as to enable the secondary controller 82 to control the display 9 to present the visual output. When it is determined that the second current value exceeds the current threshold, in step S407, the secondary controller 82 determines that the power supply 3 operates abnormally, outputs a secondary notification signal to the primary controller 81, and controls the display 9 to present the visual output.

In step S406, the primary controller 81 determines whether the secondary notification signal is received from the secondary controller 82 within the preset notification period. When it is determined that the secondary notification signal is not received within the preset notification period, the flow of the procedure proceeds to step S409. Oppositely, when it is determined that the secondary notification signal is received within the preset notification period, the flow of the procedure proceeds to step S410.

In step S408, the secondary controller 82 determines whether the primary notification signal is received from the primary controller 81 within the preset notification period. When it is determined that the primary notification signal is received within the preset notification period, the flow of the procedure proceeds to step S411. In some embodiments, when it is determined in step S408 that the primary notification signal is not received within the preset notification period, the secondary controller 82 will not execute any further steps.

In step S409, the primary controller 81 controls the driving unit 4 to operate in the normal mode.

In step S410, the primary controller 81 controls the driving unit 4 to operate in the abnormal mode so as to stop operation of the motor 43.

In step S411, the secondary controller 82 controls the display 9 to present the visual output.

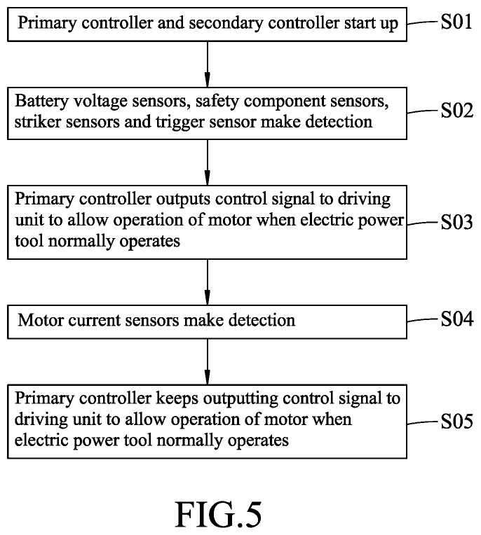

FIG. 5 illustrates an embodiment of an operation procedure of the electric power tool according to the disclosure. The operation procedure includes steps S01 to S05 delineated below.

In step S01, after the user turns on the electric power tool, e.g., by operating a power switch (not shown) of the electric power tool, the primary controller 81 and the secondary controller 82 start up.

In step S02, the first battery voltage sensor 61, the first safety component sensor 62, the first striker sensor 63, the trigger sensor 65, the second battery voltage sensor 71, the second safety component sensor 72 and the second striker sensor 73 start to make detection.

In step S03, the primary controller 81 makes the first determinations related to the condition of the battery 31, the safety component 52, the trigger 51, and the striker 631 according to the detection made by the first battery voltage sensor 61, the first safety component sensor 62, the first striker sensor 63 and the trigger sensor 65. Similarly, the secondary controller 82 makes the second determinations related to the condition of the battery 31, the safety component 52, the trigger 51, and the striker 631 according to the detection made by the second battery voltage sensor 71, the second safety component sensor 72, the second striker sensor 73 and the trigger sensor 65. After each of the primary controller 81 and the secondary controller 82 makes the aforesaid determinations, one of the primary controller 81 and the secondary controller 82 may notify the other one of the primary controller 81 and the secondary controller 82. When determining that the electric power tool operates abnormally, the primary controller 81 outputs the control signal to the driving unit 4 to disable operation of the motor 43 and the secondary controller 82, and controls the display 9 to present the visual output. On the other hand, when determining that the electric power tool operates normally, at least based on the aforesaid determinations, the primary controller 81 outputs another control signal to the driving unit 4 so as to enable operation of the motor 43.

In step S04, the first motor current sensor 64 and the second motor current sensor 74 start to make detection of the current value of the motor 43.

In step S05, the primary controller 81 makes the first determination related to the condition of the motor 43 according to the detection made by the first motor current sensor 64. Similarly, the secondary controller 82 makes the second determination related to the condition of the motor 43 according to the detection made by the second motor current sensor 74. When it is determined that the first current value or the second current value exceeds the current threshold (i.e., the electric power tool operates abnormally), one of the primary controller 81 and the secondary controller 82 notifies the other one of the primary controller 81 and the secondary controller 82, and the primary controller 81 outputs the control signal to the driving unit 4 to disable operation of the motor 43 and the secondary controller 82 controls the display 9 to present the visual output. On the other hand, when the primary controller 81 determines that the first current value does not exceed the current threshold and the secondary controller 82 determines that the second current value does not exceed the current threshold (i.e., the electric power tool operates normally), the primary controller 81 keeps outputting the another control signal to the driving unit 4 so as to enable operation of the motor 43.

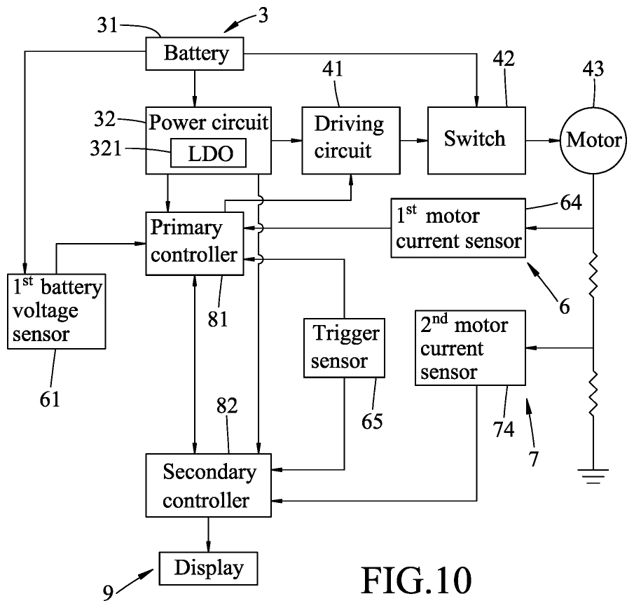

Referring to FIG. 10, a second embodiment of the electric power tool according to the disclosure is illustrated. The second embodiment of the electric power tool is similar to the first embodiment of the electric power tool, but is different therefrom in aspects described as follows.

The main sensing unit 6 includes the first battery voltage sensor 61, the first motor current sensor 64 and the trigger sensor 65; the first safety component sensor 62 and the first striker sensor 63 are omitted in this embodiment.

The redundant sensing unit 7 includes the second motor current sensor 74; the second battery voltage sensor 71, the second safety component sensor 72 and the second striker sensor 73 are omitted in this embodiment.

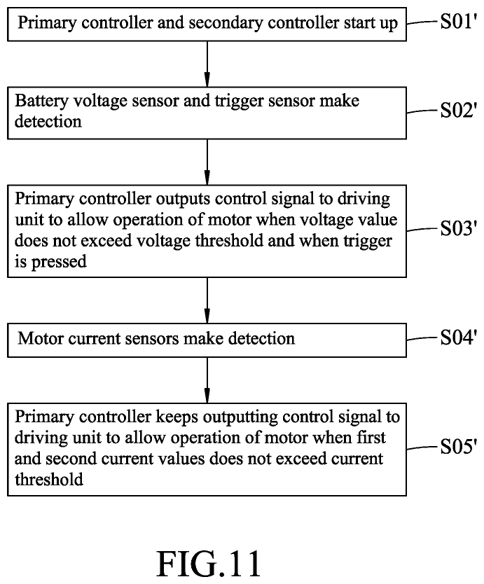

FIG. 11 illustrates a variant embodiment of the operation procedure of the electric power tool according to the disclosure. The operation procedure includes steps S01′ to S05′ delineated below.

In step S01′, after the user turns on the electric power tool, e.g., by operating the power switch (not shown) of the electric power tool, the primary controller 81 and the secondary controller 82 start up. It is worth to note that in some embodiments, the electric power tool can be turned on by using the trigger 51.

In step S02′, the first battery voltage sensor 61 and the trigger sensor 65 start to make detection.

In step S03′, the primary controller 81 makes the first determinations related to the condition of the battery 31 and the trigger 51 according to the detection made by the first battery voltage sensor 61 and the trigger sensor 65. When determining that a voltage value detected by the first battery voltage sensor 61 exceeds the voltage threshold (i.e., the electric power tool operates abnormally), the primary controller 81 outputs the control signal to the driving unit 4 to disable operation of the motor 43, and notifies the secondary controller 82 to control the display 9 to present the visual output. On the other hand, when determining that the first voltage value does not exceed the voltage threshold (i.e., the electric power tool operates normally) and that the trigger 51 is pressed, the primary controller 81 outputs another control signal to the driving unit 4 so as to enable operation of the motor 43.

In step S04′, the first motor current sensor 64 and the second motor current sensor 74 start to make detection on the current value of the motor 43.

In step S05′, the primary controller 81 makes the first determination related to the condition of the motor 43 according to the detection made by the first motor current sensor 64. Similarly, the secondary controller 82 makes the second determination related to the condition of the motor 43 according to the detection made by the second motor current sensor 74. When it is determined that the first current value or the second current value exceeds the current threshold (i.e., the electric power tool operates abnormally), one of the primary controller 81 and the secondary controller 82 notifies the other one of the primary controller 81 and the secondary controller 82, and the primary controller 81 outputs the control signal to the driving unit 4 to disable operation of the motor 43, and the secondary controller 82 controls the display 9 to present the visual output. On the other hand, when the primary controller 81 determines that the first current value does not exceed the current threshold and the secondary controller 82 determines that the second current value does not exceed the current threshold (i.e., the electric power tool operates normally), the primary controller 81 keeps outputting the another control signal to the driving unit 4 so as to enable operation of the motor 43.

It should be noted that in some embodiments, the secondary controller 82 may be further configured to output a control signal to the driving unit 4 to disable or enable operation of the motor 43.

In sum, the electric power tool according to the disclosure utilizes redundancy in sensing unit and control unit (i.e., the redundant sensing unit 7 and the secondary controller 82 that are redundancy respectively for the main sensing unit 6 and the primary controller 81) to enhance reliability and safety in using the electric power tool. By virtue of independent double-checking realized by redundancy, danger of using the electric power tool while the electric power tool operates abnormally due to failure of a single sensor or a single controller may be alleviated. It is worth to note that the primary controller 81 is dedicated to control the driving unit 4, and the secondary controller 82 is dedicated to control the display 9. Such task division may reduce workload of each of the primary controller 81 and the secondary controller 82.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric power tool, comprising:
a housing;
a power supply accommodated in said housing, and configured to supply electricity;
a driving unit accommodated in said housing, electrically connected to said power supply, and configured to drive operation of said electric power tool based on the electricity from said power supply;
an operation unit disposed on said housing, and configured to be operated by a user for using said electric power tool;
a main sensing unit accommodated in said housing, and configured to detect said power supply, said driving unit and said operation unit;
a redundant sensing unit accommodated in said housing, and configured to detect at least one of said power supply, said driving unit and said operation unit; and
a control unit electrically connected to said power supply, said driving unit and said operation unit, and including
a primary controller in communication with said main sensing unit, and configured to make a first determination related to condition of said power supply, said driving unit and said operation unit according to the detection made by said main sensing unit, and
a secondary controller in communication with said redundant sensing unit, and configured to make a second determination related to condition of at least one of said power supply, said driving unit and said operation unit according to the detection made by said redundant sensing unit,
wherein said control unit is configured to control said driving unit to operate in a normal mode where said driving unit enables said electric power tool to function normally when both of the first determination and the second determination indicate that said at least one of said power supply, said driving unit and said operation unit operates normally.

2. The electric power tool as claimed in claim 1, wherein said control unit is further configured to control said driving unit to operate in an abnormal mode where said driving unit disables said electric power tool from functioning normally when one of the first determination and the second determination indicates that said at least one of said power supply, said driving unit and said operation unit operates abnormally.

3. The electric power tool as claimed in claim 1, wherein said main sensing unit includes a plurality of types of sensors for detecting said power supply, said driving unit and said operation unit, and said redundant sensing unit includes at least one type of sensor that is a type identical to one of the types of sensors of said main sensing unit and that is for detecting one of said power supply, said driving unit and said operation unit.

4. The electric power tool as claimed in claim 3, wherein said main sensing unit at least includes a battery voltage sensor and a motor current sensor.

5. The electric power tool as claimed in claim 4, wherein said power supply includes a battery, and said battery voltage sensor is configured to detect a voltage value of said battery.

6. The electric power tool as claimed in claim 4, wherein said driving unit includes a motor, and said motor current sensor is configured to detect a current value of said motor.

7. The electric power tool as claimed in claim 3, wherein said main sensing unit at least includes a safety component sensor and a striker sensor.

8. The electric power tool as claimed in claim 7, wherein said operation unit includes a safety component, and said safety component sensor is configured to determine whether said safety component is pressed.

9. The electric power tool as claimed in claim 7, further comprising a striker, wherein said striker sensor is configured to determine whether said striker returns to a predetermined position after said electric power tool has been triggered.

10. The electric power tool as claimed in claim 1, wherein:
said secondary controller is further configured to output a notification signal to said primary controller when the second determination indicates that said at least one of said power supply, said driving unit and said operation unit operates normally; and
said primary controller is in communication with said secondary controller, is electrically connected to said driving unit, and is further configured to output a control signal to said driving unit for controlling said driving unit to operate in one of the normal mode and an abnormal mode where said driving unit disables said electric power tool from functioning normally based on the first determination and whether the notification signal is received.

11. The electric power tool as claimed in claim 1, wherein:
said secondary controller is further configured to output a notification signal to said primary controller when the second determination indicates that said at least one of said power supply, said driving unit and said operation unit operates abnormally; and
said primary controller is in communication with said secondary controller, is electrically connected to said driving unit, and is further configured to output a control signal to said driving unit for controlling said driving unit to operate in one of the normal mode and an abnormal mode where said driving unit disables said electric power tool from functioning normally based on the first determination and whether the notification signal is received.

12. The electric power tool as claimed in claim 1, further comprising a display electrically connected to said secondary controller,
wherein said secondary controller is further configured to control said display to present a visual output when it is determined that said at least one of said power supply, said driving unit and said operation unit operates abnormally.

13. The electric power tool as claimed in claim 1, wherein:
said operation unit includes a striker;
said main sensing unit includes a first striker sensor that is configured to determine whether said striker returns to a predefined position after said electric power tool has been triggered, and to output a first striker-detection signal to said primary controller when it is determined that said striker returns to the predefined position;
said redundant sensing unit includes a second striker sensor that is configured to determine whether said striker returns to the predefined position after said electric power tool has been triggered, and to output a second striker-detection signal to said secondary controller when it is determined that said striker returns to the predefined position;
said secondary controller is configured to determine whether the second striker-detection signal is received, and to output a notification signal to said primary controller when it is determined that the second striker-detection signal is received;
said primary controller is configured to determine whether the first striker-detection signal is received, to determine whether the notification signal is received when it is determined that the first striker-detection signal is received, to control said driving unit to operate in the normal mode when it is determined that the notification signal is received, and to control said driving unit to operate in an abnormal mode where said driving unit disables said electric power tool from functioning normally when it is determined that the notification signal is not received.

14. The electric power tool as claimed in claim 1, wherein:
said operation unit includes a safety component and a trigger;
said main sensing unit includes
a first safety component sensor that is configured to determine whether said safety component is pressed, and to output a first safety-component-pressed signal to said primary controller when it is determined that said safety component is pressed, and
a trigger sensor that is configured to determine whether said trigger is pressed, and to output a first trigger-pressed signal and a second trigger-pressed signal respectively to said primary controller and said secondary controller when it is determined that said trigger is pressed;
said redundant sensing unit includes a second safety component sensor that is configured to determine whether said safety component is pressed, and to output a second safety-component-pressed signal to said secondary controller when it is determined that said safety component is pressed;
said secondary controller is configured to
determine whether the second safety-component-pressed signal and the second trigger-pressed signal are received, and
when it is determined that the second safety-component-pressed signal and the second trigger-pressed signal are received, output a notification signal to said primary controller;
said primary controller is configured to determine whether the first safety-component-pressed signal and the first trigger-pressed signal are received,
determine, when it is determined that the first safety-component-pressed signal and the first trigger-pressed signal are received, whether the notification signal is received,
control said driving unit to operate in the normal mode when it is determined that the notification signal is received, and
control said driving unit to operate in an abnormal mode where said driving unit disables said electric power tool from functioning normally when it is determined that the notification signal is not received.

15. The electric power tool as claimed in claim 1, wherein:
said power supply includes a battery;
said main sensing unit includes a first battery voltage sensor that is configured to detect a first voltage value of said battery, and to output the first voltage value to said primary controller;
said redundant sensing unit includes a second battery voltage sensor that is configured to detect a second voltage value of said battery, and to output the second voltage value to said secondary controller;
said secondary controller is configured to
determine whether the second voltage value exceeds a voltage threshold, and
when it is determined that the second voltage value exceeds the voltage threshold, determine that said power supply operates abnormally and output a notification signal to said primary controller,
said primary controller is configured to
determine whether the first voltage value exceeds the voltage threshold,
control said driving unit to operate in an abnormal mode where said driving unit disables said electric power tool from functioning normally when it is determined that the first voltage value exceeds the voltage threshold,
determine whether the notification signal is received when it is determined that the first voltage value does not exceed the voltage threshold, and
control said driving unit to operate in the abnormal mode when the notification signal is received and to operate in the normal mode when the notification signal is not received.

16. The electric power tool as claimed in claim 1, wherein:
said driving unit includes a motor;
said main sensing unit includes a first motor current sensor that is configured to detect a first current value of said motor, and to output the first current value to said primary controller;
said redundant sensing unit includes a second motor current sensor that is configured to detect a second current value of said motor, and to output the second current value to said secondary controller;
said secondary controller is configured to
determine whether the second current value exceeds a current threshold, and
when it is determined that the second current value exceeds the current threshold, determine that said electric power tool operates abnormally and output a notification signal to said primary controller;
said primary controller is configured to,
determine whether the first current value exceeds the current threshold,
control said driving unit to operate in an abnormal mode where said driving unit disables said electric power tool from functioning normally when it is determined that the first current value exceeds the current threshold,
determine whether the notification signal is received when it is determined that the first current value does not exceed the current threshold, and
control said driving unit to operate in the abnormal mode when the notification signal is received and to operate in the normal mode when the notification signal is not received.
